(19) United States
(12) Patent Application Publication
(10) Pub. No.: US 2006/0171552 A1
(43) Pub. Date: Aug. 3, 2006

(54) Microphone wiht sliding battery compartment

(76) Inventor: Cheng-Shun Chiu, Panchiao City (TW)

Correspondence Address: LEONG C LEI, PMB # 1008, 1867 YGNACIO VALLEY ROAD, WALNUT CREEK, CA, 94598, US

(21) Appl. No.: 11/047,631

(22) Filed: Feb. 2, 2005

(51) Int. Cl. H04R 11/04

(52) U.S. Cl. 381/360; 381/355; 381/362

(57) ABSTRACT

A microphone with sliding battery compartment is disclosed. The microphone comprises a body axially provided with a hollow recess and the end section of the body being provided with a fastening hole; a sound-receiving unit mounted to the recess such that the end section thereof contains a power supply elastic disc; a battery compartment correspondingly and sliding mounted at the recess of the body such that the end terminal thereof urges the power supply elastic disc and the front section of the battery compartment being a first fastening section and the end section of the battery compartment being elastically mounted a second fastening section and the first and second fastening section respectively corresponding to the fastening hole of the body and move together with the battery compartment to correspondingly fasten to the fastening hole; and an operating ring pivotally mounted to the end section of the body containing a fastening-releasing elastic disc which can be rotated to align with the external edge of the fastening hole and being pressed to move the second fastening section so as to release the fastening of the operating ring from the body.

### BACKGROUND OF THE INVENTION

(a) Technical Field of the Invention

The present invention relates to a microphone with battery compartment, and in particular, a battery compartment which is automatically extended out by a pressing action on a button-releasing elastic disc.

(b) Description of the Prior Art

Conventional microphone includes a battery cylinder and a sound-receiving section. The battery cylinder is locked to the bottom end of the sound-receiving section so as to supply power to the sound-receiving section. The drawbacks of the conventional microphone includes:

1. Locking the battery cylinder to the sound-receiving section by way of screwing which is not secured. The sound vibration of the microphone will result in poor connection. Furthermore, when unloading the battery cylinder, the cylinder has to be unwound several times. This is not convenient in the process of replacement of batteries.

2. Fastening by elastic snap is not secured for the reason that an accidental touch of the button may cause a separation of the battery cylinder from the microphone. In view of the above, it is an object of the present invention to provide microphone with a sliding battery compartment which above-mentioned drawbacks.

### SUMMARY OF THE INVENTION

The primary purpose of the present invention is to provide a microphone with sliding battery compartment comprising a body axially provided with a hollow recess and the end section of the body being provided with a fastening hole; a sound-receiving unit mounted to the recess such that the end section thereof contains a power supply elastic disc; a battery compartment correspondingly and slide mounted at the recess of the body such that the end terminal thereof urges the power supply elastic disc and the front section of the battery compartment being a first fastening section and the end section of the battery compartment being elastically mounted a second fastening section and the first and second fastening section respectively corresponding to the fastening hole of the body and move together with the battery compartment to correspondingly fasten to the fastening hole; and an operating ring pivotally mounted to the end section of the body containing a fastening-releasing elastic disc which can be rotated to align with the external edge of the fastening hole and being pressed to move the second fastening section so as to release the fastening of the operating ring from the body.

Yet another object of the present invention is to provide a microphone with sliding battery compartment, wherein the external edge at the external end is a fastening slot having axial slot and the front end of the axial slot is a horizontal slot such that an L-shaped is formed, and the horizontal slot is provided with a positioning fastening section correspondingly connect to the positioning protrusion, and the positioning protrusion is fastened to the positioning fastening section of the horizontal slot, and the fastening-releasing elastic disc of the operating ring is projected at one side of the fastening hole of the body.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded perspective view of the present invention.

FIG. 2 is a perspective view of the present invention.

FIG. 3 is a schematic view showing the operating ring being rotated to an angle of FIG. 2.

FIG. 4 is a partial sectional view along line 4-4 of FIG. 3 of the present invention.

FIG. 5 is a schematic view showing the second fastening section of FIG. 4 and the releasing of the fastening section of the present invention.

FIG. 6 is a schematic view showing the withdrawal of the battery compartment of the present invention.

FIG. 7 is a schematic view showing the battery compartment being pushed into the microphone in accordance with the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

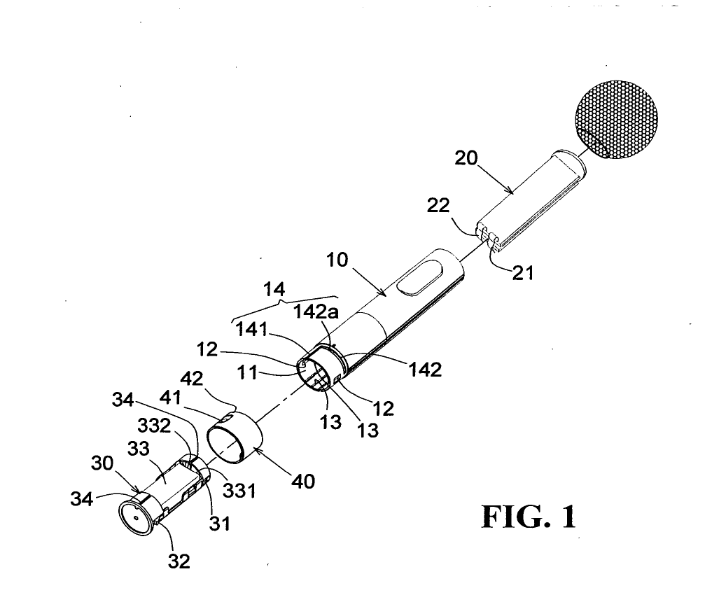

Referring to FIGS. 1 to 7, there is shown a microphone having a sliding battery compartment including a body 10, a sound-receiving unit 20 mounted within the body 10; a battery compartment 30 slide-mounted within the body 10 and electrically connected to the sound-receiving unit 20, and the front section of the battery compartment 30 elastically mounted to a first fastening section 31, and the rear section of the battery compartment 30 electrically mounted to a second fastening section 33 and the first and second fastening section 31, 32 slides within the body 10 of the battery compartment 30 and corresponding to fasten with the fastening hole 12 provided at the end section of the body 10; and an operating ring 40 pivotally mounted to the end section of the body 10 containing fastening-releasing elastic disc 41 which rotates and is aligned with the external edge of the fastening hole 12, and when the elastic disc 41 being pressed, the second fastening section 32 on the battery compartment 30 being moved and disengage with the body 10 so that the battery compartment 30 can be quickly extended out from the compartment 10.

As shown in FIGS. 1 to 4, the body 10 is a hollow cylinder having a recess 11. The wall of the recess 11 has at least a guiding rail 13 so as to match with the guiding slot 34 and the battery compartment 30 can slide to the recess 11 of the body 10.

The end section of the body 10 has a fastening slot 14 and the fastening slot 14 has an end edge provided with an axial slot 141, and the front end of the axial slot 141 has a horizontal slot 142 such that the axial slot 141 and the horizontal slot 142 are formed into an L-shaped structure so as to guide the operating ring 40 to a positioning protrusion 42 and slides into the axial slot 141, an angle can be rotated and placed at the horizontal slot 142 such that the operating ring 40 is secured and fastened to the end section of the body 10.

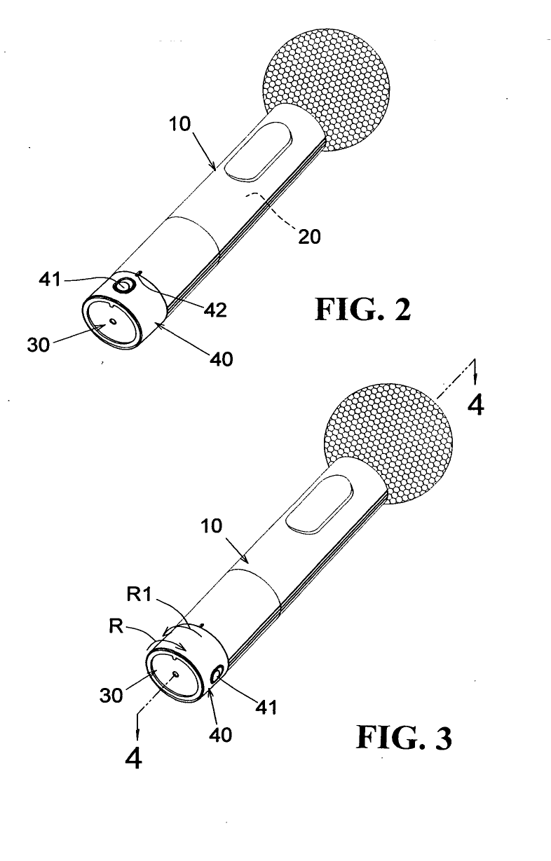

The horizontal slot 142 has a positioning section 142a to correspond with the positioning protrusion 42 so as to stop the operating ring 40. As shown in FIG. 2, the fastening-releasing elastic disc 41 is projected at one side of the fastening hole 12 of the body 10. The user will not press the fastening-releasing elastic disc 41 to move the second fastening section 32 and the battery compartment 30 is secured to the body 10 and the battery compartment 30 is locked at the recess 11 of the body 10.

The sound-receiving unit 20 has an end terminal mounted with power supply connection discs 21,22, elastically urging the battery 33 in the battery compartment 30 to the electrodes 331,332. When the second fastening second 32 is released from the body 10, the power supply connection disc 21, 221 will elastically extend outward to urge the battery compartment 30 so that the replacement of batteries is simple.

As shown in FIGS. 1 and 2, the protrusion 42 corresponding to the positioning fastening section 142a so that the fastening-releasing elastic disc 41 is at one side of the fastening hole 12 such that the user cannot press the elastic disc 41 and the second fastening section 32 is secured to the body 10.

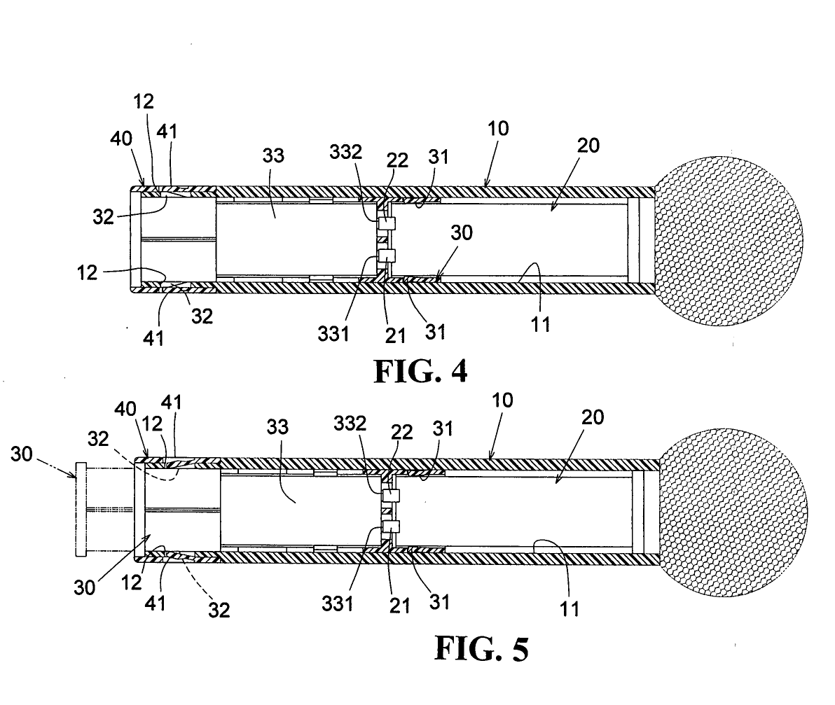

When the batteries are to be replaced, as shown in FIG. 3, the operating ring 40 rotates in R direction and the elastic disc 41 is projected outside the fastening hole 12, as shown in FIG. 4. Thus, the user presses the elastic disc 41, the fastening of the second fastening section 32 with the fastening hole 12 is released.

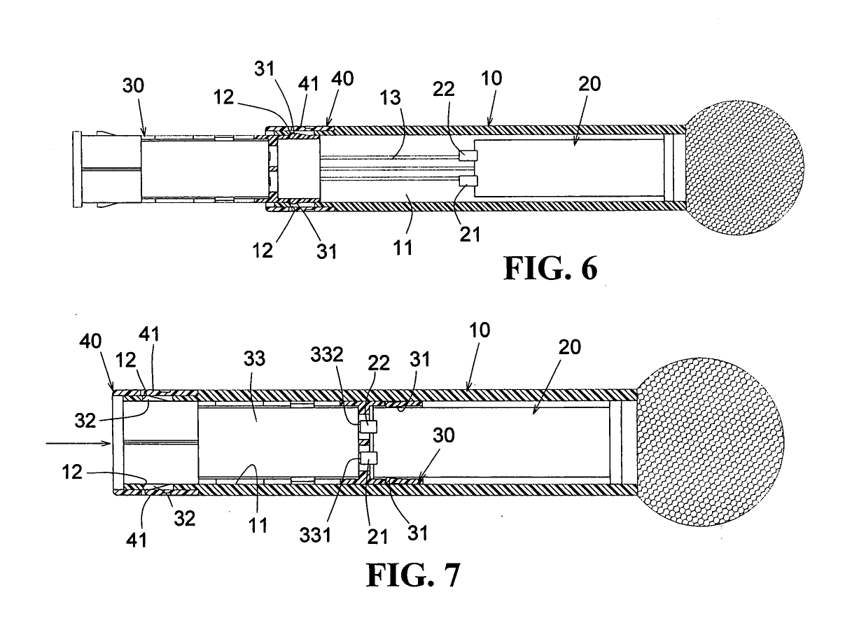

As shown in FIGS. 4 and 5, the power supply connection disc 21, 22 is elastically moved backward a little to urge the battery compartment 30, the user can withdraw backward the battery compartment 30 from the recess 11. When the battery compartment 30 is withdrawn 30 till the first fastening section 31 is corresponding to the fastening hole 12, it stops. As shown in FIG. 6, the fastening section 31 to stop the fully withdrawal of the battery compartment 30 to disengage with the recess 11. At this instance, the user can replace the batteries.

After the batteries are replaced, as shown in FIG. 6, the battery compartment 30 is pushed into the recess 11. At this instance, the first fastening section 31 is released from the fastening hole 12 of the body 10, and thus, the battery compartment 30 will stop when the second fastening section 32 at the end section of the battery compartment 30 is engaged with the fastening hole 12 of the body 10. As shown in FIG. 7, the user can rotate the operating ring 40 in direction. R1 as shown in FIG. 3 such that the positioning protrusion 42 is corresponding to the positioning fastening section 142a of the end section, fastening slot 14. That is the fastening-releasing disc 41 is projected at one side of the fastening hole 12.

As shown in FIGS. 1 and 2, the user cannot move the battery compartment 30 by pressing the fastening-releasing disc 41 and therefore the battery compartment 30 is secured to the body 10. Thus, if the microphone is accidentally dropped to the ground, the battery compartment 30 will not be dropped off from the microphone.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A microphone with sliding battery compartment comprising:
a body axially provided with a hollow recess and the end section of the body being provided with a fastening hole;
a sound-receiving unit mounted to the recess such that the end section thereof contains a power supply elastic disc;
a battery compartment correspondingly and slide-mounted at the recess of the body such that the end terminal thereof urges the power supply elastic disc and the front section of the battery compartment being a first fastening section and the end section of the battery compartment being elastically mounted a second fastening section and the first and second fastening section respectively corresponding to the fastening hole of the body and move together with the battery compartment to correspondingly fasten to the fastening hole; and
an operating ring pivotally mounted to the end section of the body containing a fastening-releasing elastic disc which can be rotated to align with the external edge of the fastening hole and being pressed to move the second fastening section so as to release the fastening of the operating ring from the body.

2. The microphone with sliding battery compartment of claim 1, wherein the body is a hollow cylinder axially provided with a recess, and the wall of the recess being guided rails to match a guide slot provided on the external edge of the battery compartment.

3. The microphone with sliding battery compartment of claim 1, wherein the external edge at the external end is a fastening slot having axial slot and the front end of the axial slot is a horizontal slot such that an L-shaped is formed, and the horizontal slot is provided with a positioning fastening section correspondingly connect to the positioning protrusion, and the positioning protrusion is fastened to the positioning fastening section of the horizontal slot, and the fastening-releasing elastic disc of the operating ring is projected at one side of the fastening hole of the body.
